(19) United States
(12) Patent Application Publication
(10) Pub. No.: US 2015/0041050 A1
(43) Pub. Date: Feb. 12, 2015

(54) METHOD FOR MAKING CURVED TOUCH MODULE

(71) Applicant: TIANJIN FUNAYUANCHUANG TECHNOLOGY CO., LTD., Tianjin (CN)

(72) Inventors: HAN-CHUNG CHEN, New Taipei (TW); CHIH-HAN CHAO, New Taipei (TW); PO-SHENG SHIH, New Taipei (TW)

(21) Appl. No.: 14/452,546

(22) Filed: Aug. 6, 2014

(30) Foreign Application Priority Data
Aug. 9, 2013 (CN) 2013103455875

(51) Int. Cl. B32B 38/00; G06F 3/041

(52) U.S. Cl. CPC B32B 38/0036; G06F 3/041; G06F 2203/04103; B32B 2313/04
USPC 156/212

(57) ABSTRACT

A method of making a curved touch module with curved surface includes following steps. A first substrate with a first surface is provided. A carbon nanotube composite structure is formed by locating a carbon nanotube conductive layer on the first surface. The carbon nanotube composite structure is curved by applying pressure onto the carbon nanotube composite structure, wherein the first surface forms a curved surface, and the carbon nanotube conductive layer is attached on the curved surface.

### CROSS-REFERENCE TO RELATED APPLICATIONS

This application claims all benefits accruing under 35 U.S.C. §119 from China Patent Application No. 201310345587.5, filed on Aug. 9, 2013, in the China Intellectual Property Office, the disclosure of which is incorporated herein by reference.

### FIELD

The present disclosure relates to a method of making curved touch module with curved surface, particularly to a method of making curved touch module with curved carbon nanotube film.

### BACKGROUND

In recent years, with the development of the high performance of electronic devices such as mobile phone and touch navigation systems, liquid crystal displays mounted with a transparent touch module in front of the electronic devices are gradually increased. Thus, the electronic devices have various functions.

Resistive touch module and capacitive touch module are two common types. The resistive touch module includes at least one transparent electrode layer. However, in the method of making resistive touch module and capacitive touch module, an ITO (indium-tin oxide) glass is used as the transparent electrode layer. Because the ITO glass is a brittle material, and the toughness is limited, thus the resistive touch module and capacitive touch module is limited to planar surface which is only applied in the flat liquid crystal displays.

What is needed, therefore, is to provide a method of making touch module with curved surface for solving the problem discussed above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a schematic flowchart of one embodiment of making a curved touch module.

FIG. 2 shows a scanning electron microscope image of a drawn carbon nanotube film.

FIG. 3 shows a schematic view of one embodiment of a device for making the curved touch module of FIG. 1.

FIG. 4 shows a schematic view of one embodiment of attaching the curved touch module with a substrate.

FIG. 5 shows a schematic view of one embodiment of applying a plurality of first electrodes and a plurality of second electrodes on a carbon nanotube composite structure.

FIG. 6 a schematic flowchart of one embodiment of making a curved touch module.

FIG. 7 shows a schematic view of one embodiment of a device for making the curved touch module of FIG. 1.

FIG. 8 shows a schematic view of one embodiment of a die in the device of FIG. 7.

FIG. 9 shows an image of the die of FIG. 8.

FIG. 10 shows a schematic view of one embodiment of a fixture in the device of FIG. 7.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

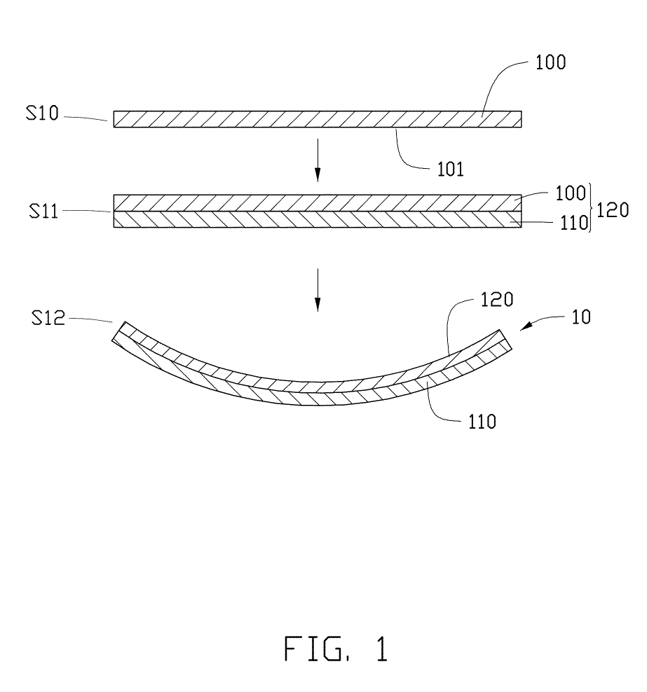

Referring to FIG. 1, one embodiment of a method for making a curved touch module 10 with curved surface comprises following steps:

(S10), providing a first substrate 100;

(S11), forming a carbon nanotube composite structure 120 by placing a carbon nanotube conductive layer 110 on a first surface 101 of the first substrate 100; and

(S12), bending the carbon nanotube composite structure 120.

In step (S10), a material of the first substrate 100 can be a thermoplastic material. Furthermore, the material of the first substrate 100 can be a flexible material. The flexible material can be polycarbonate (PC), polymethyl methacrylate (PMMA), polyethylene terephthalate (PET) and other polyester materials, and polyether sulfone (PES), cellulose esters, polyvinyl chloride (PVC), benzocyclobutene (BCB), or acrylic resin. In one embodiment, the material of the first substrate 100 is PET. The thermoplastic material may be rigid at room temperature, but can be transferred into plastic material or flexible material while the thermoplastic material is heated to a predetermined temperature. The first substrate 100 can have a uniform thickness. The thickness of the first substrate 100 ranges from about 0.1 millimeters to about 1 centimeter. In one embodiment, the thickness of the first substrate 100 ranges from about 0.1 millimeters to about 0.5 millimeters, and the first substrate 100 has better flexibility. The first surface 101 of the first substrate 100 can be a flat surface for conveniently attaching the carbon nanotube conductive layer 110.

In step (S11), the carbon nanotube conductive layer 110 can be attached on the first surface of the substrate 100. In one embodiment, the first carbon nanotube conductive layer 110 can be directly attached on the first surface 101. Furthermore, the carbon nanotube conductive layer 110 can also be attached on the first surface 101 via an adhesive layer (not shown). The material of the adhesive layer can be an Optical Clear Adhesive (OCA).

The carbon nanotube conductive layer 110 can be transparent. The carbon nanotube conductive layer 110 comprises a plurality of carbon nanotubes parallel with each other. The plurality of carbon nanotubes are oriented substantially parallel with the first surface 101. In one embodiment, the carbon nanotube conductive layer 110 comprises at least one carbon nanotube film. The carbon nanotube film comprises a plurality of carbon nanotubes orderly aligned. The plurality of carbon nanotubes are substantially aligned along the same direction. The carbon nanotube conductive layer 110 can be an anisotropic impedance layer defining a relatively low impedance direction parallel with the alignment of the plurality of carbon nanotubes, and a relatively high impedance direction perpendicular to the relative low impedance direction.

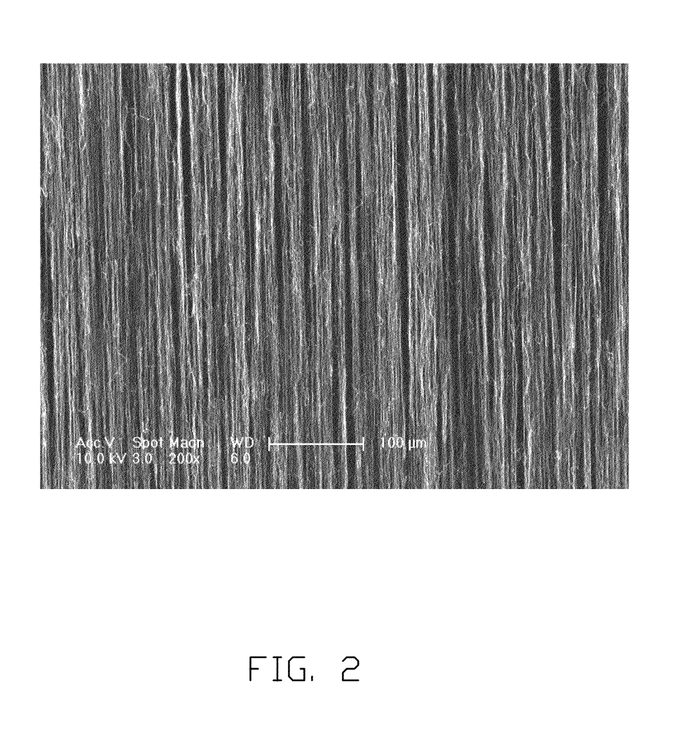

Referring to FIG. 2, the carbon nanotube conductive layer 110 can be a drawn carbon nanotube film. In one embodiment, the carbon nanotube conductive layer 110 comprises a plurality of drawn carbon nanotube film stacked together. A thickness of the carbon nanotube conductive layer 110 can ranges from about 0.5 nanometers to about 1 millimeter. In one embodiment, the thickness of the carbon nanotube conductive layer 110 ranges from about 100 nanometers to about 0.1 millimeters. The transmittance of the carbon nanotube conductive layer 110 is related with the thickness of the carbon nanotube conductive layer 110. The thinner the carbon nanotube conductive layer 110, the better the transmittance of the carbon nanotube conductive layer 110. The transmittance of the carbon nanotube conductive layer 110 can reach 90%. The drawn carbon nanotube film has a large specific surface area, thus the drawn carbon nanotube film can be directly attached to first surface 101.

The carbon nanotube film can be formed by drawing the film from a carbon nanotube array. The overall aligned direction of a majority of the carbon nanotubes in the carbon nanotube film is substantially aligned along the same direction and substantially parallel to a surface of the carbon nanotube film. The carbon nanotube is joined to adjacent carbon nanotubes end to end by van der Waals force therebetween, and the carbon nanotube film is capable of being a free-standing structure. A support having a large surface area to support the entire free-standing carbon nanotube film is not necessary, and only a supportive force at opposite sides of the film is sufficient. The free-standing carbon nanotube film can be suspended and maintain its film state with only supports at the opposite sides of the film. When disposing (or fixing) the carbon nanotube film between two spaced supports, the carbon nanotube film between the two supports can be suspended while maintaining its integrity. The successively and aligned carbon nanotubes joined end to end by van der Waals attractive force in the carbon nanotube film is one main reason for the free-standing property. The carbon nanotube film drawn from the carbon nanotube array has good transparency. In one embodiment, the carbon nanotube film is substantially a pure film and consists essentially of the carbon nanotubes, and to increase the transparency of the touch panel, the carbon nanotubes are not functionalized.

The plurality of carbon nanotubes in the carbon nanotube film have a preferred orientation along the same direction. The preferred orientation means that the overall aligned direction of the majority of carbon nanotubes in the carbon nanotube film is substantially along the same direction. The overall aligned direction of the majority of carbon nanotubes is substantially parallel to the surface of the carbon nanotube film, thus parallel to the surface of the polarizing layer. Furthermore, the majority of carbon nanotubes are joined end to end therebetween by van der Waals force. In this embodiment, the majority of carbon nanotubes are substantially aligned along the same direction in the carbon nanotube film, with each carbon nanotube joined to adjacent carbon nanotubes at the aligned direction of the carbon nanotubes end to end by van der Waals force. There may be a minority of carbon nanotubes in the carbon nanotube film that are randomly aligned, but the number of randomly aligned carbon nanotubes is small compared to the majority of substantially aligned carbon nanotubes and therefore will not affect the overall oriented alignment of the majority of carbon nanotubes in the carbon nanotube film.

In the carbon nanotube film, the majority of carbon nanotubes that are substantially aligned along the same direction may not be completely straight. Sometimes, the carbon nanotubes can be curved or not exactly aligned along the overall aligned direction, and can deviate from the overall aligned direction by a certain degree. Therefore, it cannot be excluded that partial contacts may exist between the juxtaposed carbon nanotubes in the majority of carbon nanotubes aligned along the same direction in the carbon nanotube film. Despite having curved portions, the overall alignment of the majority of the carbon nanotubes are substantially aligned along the same direction.

The carbon nanotube film includes a plurality of successive and oriented carbon nanotube segments. The plurality of carbon nanotube segments are joined end to end by van der Waals attractive force. Each carbon nanotube segment includes a plurality of carbon nanotubes that are substantially parallel to each other, and the plurality of parallel carbon nanotubes are in contact with each other and combined by van der Waals attractive force therebetween. The carbon nanotube segment can have a desired length, thickness, uniformity, and shape. The carbon nanotubes in the carbon nanotube film have a preferred orientation along the same direction. The carbon nanotube wires in the carbon nanotube film can consist of a plurality of carbon nanotubes joined end to end. The adjacent and juxtaposed carbon nanotube wires can be connected by the randomly aligned carbon nanotubes. There can be clearances between adjacent and juxtaposed carbon nanotubes in the carbon nanotube film. A thickness of the carbon nanotube film at the thickest location is about 0.5 nanometers to about 100 microns (e.g., in a range from 0.5 nanometers to about 10 microns).

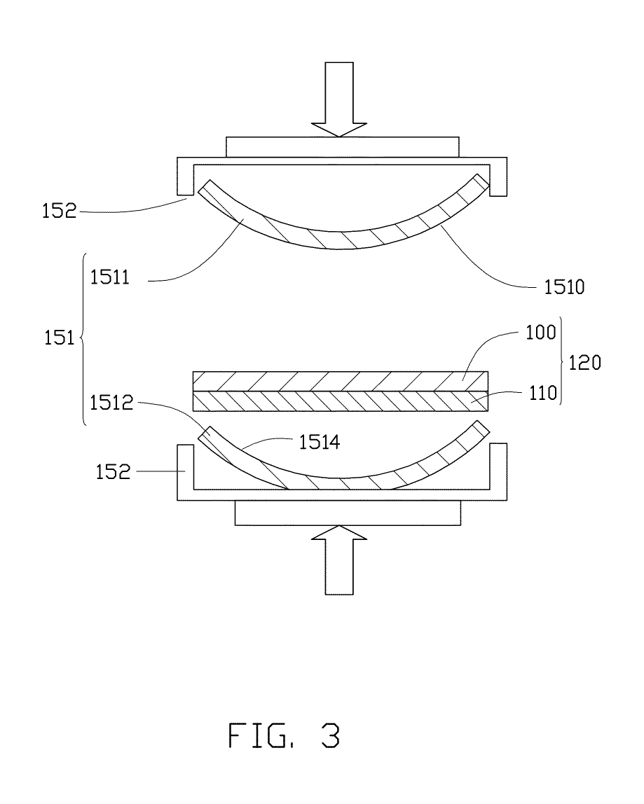

Referring to FIG. 3, in step (S12), the carbon nanotube composite structure 120 can be bent by a thermocompressor 152 and a die 151. The die 151 comprises a male die 1511 and a female die 1512 capable of being coupled with each other. The carbon nanotube composite structure 120 can be loaded in and fixed by the die 151. The male die 1511 comprises a male die surface 1510, and the female die 1512 comprises a female die surface 1514 capable of being matched with the male die surface 1510.

Both the male die surface 1510 and the female die surface 1514 can be a curved surface. The curved surface can be a surface bent along single dimension, two dimensions, or three dimensions. Thus the curved surface can be a single curved surface, double curved surface, or free-form surface. In one embodiment, the curved surface can be a free-form surface.

In one embodiment, a radian θ of the curved surface at each point on the curved surface can be selected according to need. The radian θ can range from about 115 degrees to about 180 degrees. The radian θ can also range from about 90 degrees to about 115 degrees. In one embodiment, the radian θ is greater than 100 degrees and smaller than 115 degrees. At the same time, a radius of the curved surface can be smaller than 5 millimeters.

The die 151 can be equipped into and heated by the thermocompressor 152. Thus the carbon nanotube composite structure 120 located in the die 151 can also be heated. The carbon nanotube composite structure 120 can be bent by following substeps:

first substep, equipping the die 151 into the thermocompressor 152;

second substep, heating the die 151 into a first predetermined temperature;

third substep, locating the carbon nanotube composite structure 120 into the die 151;

fourth substep, bending the carbon nanotube composite structure 120 by closing the die 151 for a first predetermined time; and

fifth substep, opening the die 151.

In first substep, the first predetermined temperature can be selected according to the material of the first substrate 100. The first substrate 100 is flexible at the first temperature. In one embodiment, the first temperature ranges from about 80° C. to about 120° C.

In third substep, the carbon nanotube composite structure 120 can be fixed on the female die surface 1510 or the male die surface 1514. Furthermore, the carbon nanotube conductive layer 110 can be bent along the alignment of the plurality of carbon nanotubes. Thus the break to the carbon nanotube conductive layer 110 can be reduced or avoided, and the affect to the conductivity of the carbon nanotube conductive layer 110 can be reduced.

In fourth substep, the die 151 can be driven by a pneumatic cylinder or a hydraulic cylinder (not shown) to apply pressure on the female die 1511. The female die 1511 and the male die 1512 can be closed under the pressure. The pressure of the pneumatic cylinder or hydraulic cylinder can be selected according to the material of first substrate 100. The first substrate 100 and the carbon nanotube conductive layer 110 can be protected from being destroyed under the pressure.

After the die 151 is closed, the first predetermined time can be selected according to the material of the first substrate 100. The first substrate 100 can be flexible for bending and being tightly attached on the male die surface 1514. Thus the carbon nanotube composite structure 120 can be bent according to the male die surface 1514. In one embodiment, the first predetermined time ranges from about 20 seconds to about 180 seconds.

In fifth substep, after the die 151 is opened, the carbon nanotube composite structure 120 can be naturally cooled down. Furthermore, the carbon nanotube composite structure 120 can be cooled in a cool device (not shown). The carbon nanotube composite structure 120 is bent to form the curved touch module 10. The first substrate 100 will also be bent and shaped according to the male die surface 1514. The first surface 101 of the first substrate 100 will be curved.

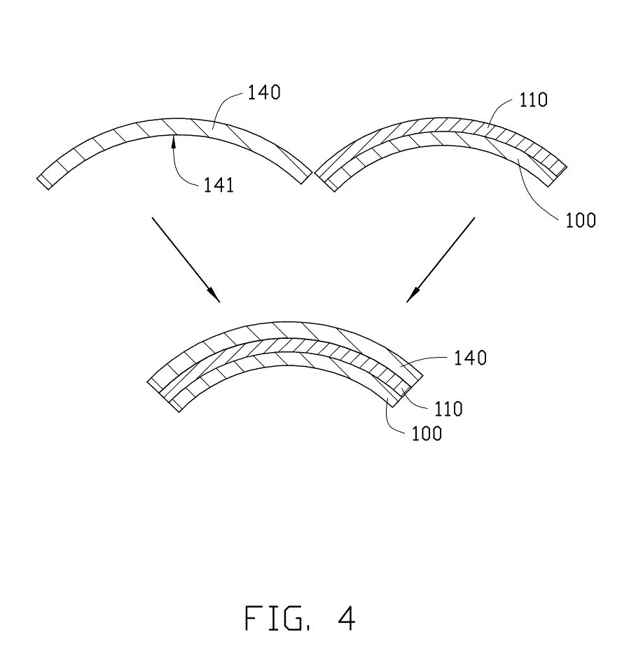

Furthermore, referring to FIG. 4, a second substrate 140 can be located on the carbon nanotube composite structure 120. The second substrate 140 is attached on a surface of the carbon nanotube conductive layer 110 away from the first substrate 100. The second substrate 140 comprises a curved second surface 141 capable of being coupled with the curved first surface 101 of the first substrate 100. Thus the second surface 141 will be tightly coupled with the first surface 101, and the carbon nanotube conductive layer 110 is sandwiched between the first surface 101 and the second surface 141. The second substrate 140 can also be a curved structure, and two opposite surface of the second substrate 140 are curved surfaces.

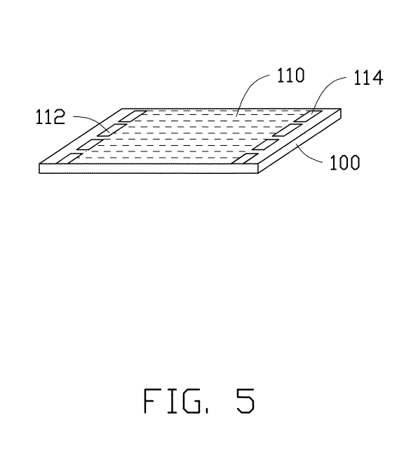

Furthermore, referring to FIG. 5, a plurality of first electrodes 112 and a plurality of second electrodes 114 can be applied on the first substrate 100 before bending the carbon nanotube composite structure 120. The plurality of first electrodes 112 and the plurality of the second electrodes 114 can be formed on the first substrate 100 to electrically connect to the carbon nanotube conductive layer 110 via screen printing method.

The first electrode 112 and second electrode 114 can be are line-shaped or strip-shaped structure. The material of the first electrode 112 and the second electrode 114 can be metal, alloy, indium tin oxide (ITO), antimony tin oxide (ATO), conductive silver paste, conductive polymer, or conductive carbon nanotube. The metal can be aluminum, copper, tungsten, molybdenum, gold, titanium, neodymium, palladium, or cesium. The material of the first electrode 112 and the second electrode 114 can also be an alloy thereof in any combination. The first electrode 112 and the second electrode 114 are disposed on the two opposite sides of the conductive carbon nanotubes 110 along the direction of the low impedance. The touch module 10 is capable of sensing touch.

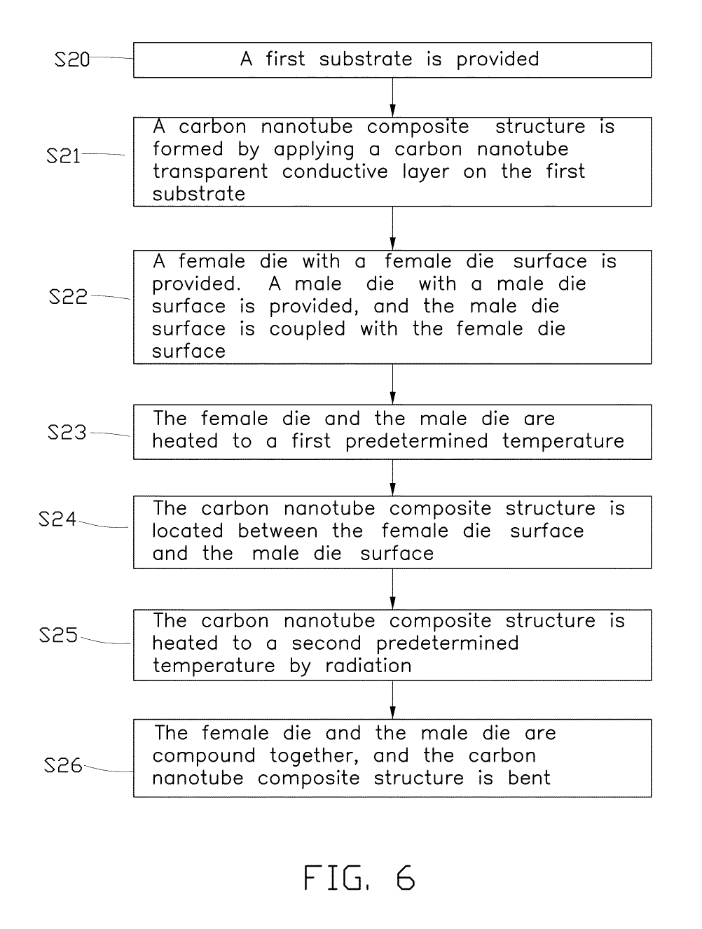

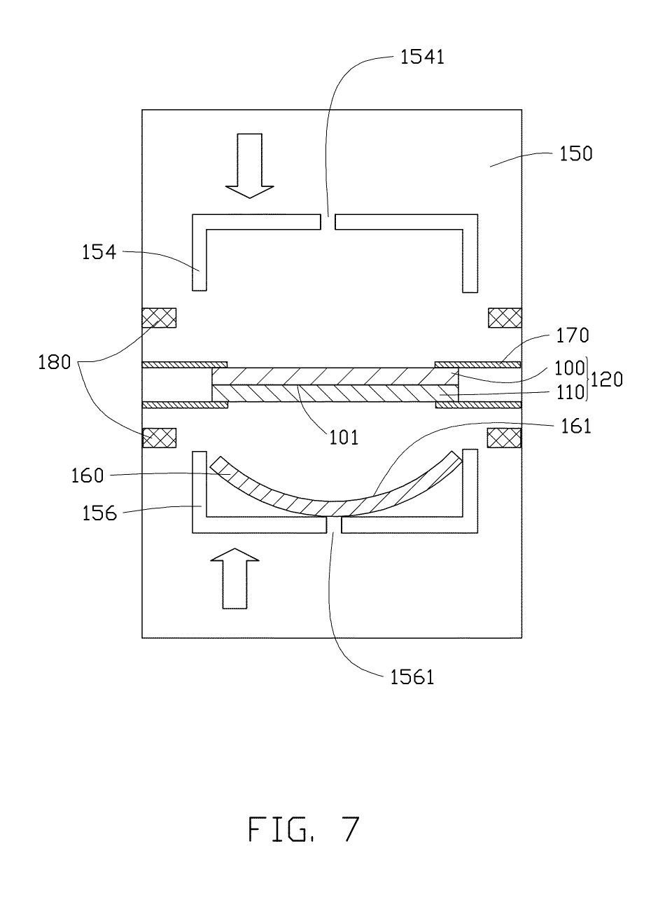

Referring to FIGS. 6-7, a method of making touch module 10 in another embodiment comprising:

(S20), proving a first substrate 100 with a first surface 101;

(S21), forming a carbon nanotube composite structure 120 by applying a carbon nanotube conductive layer 110 on the first surface 101;

(S22), providing a mold 160 having a curved surface 161;

(S23), heating the mold 160 to a first predetermined temperature;

(S24), suspending the carbon nanotube composite structure 120 above the curved surface 161;

(S25), heating the carbon nanotube composite structure 120 to a second predetermined temperature for a first predetermined time by a heating device 180;

(S26), attaching the carbon nanotube composite structure 120 on the curved surface 161 by bending the carbon nanotube composite structure 120 towards the curved surface 161.

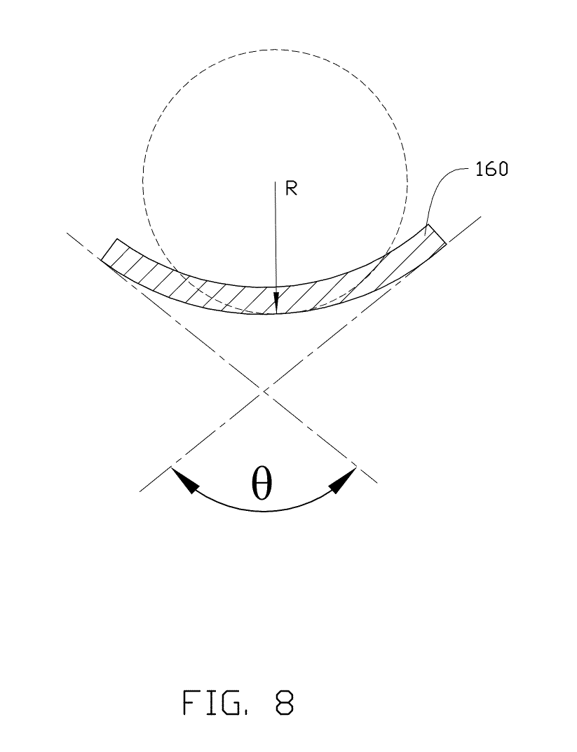

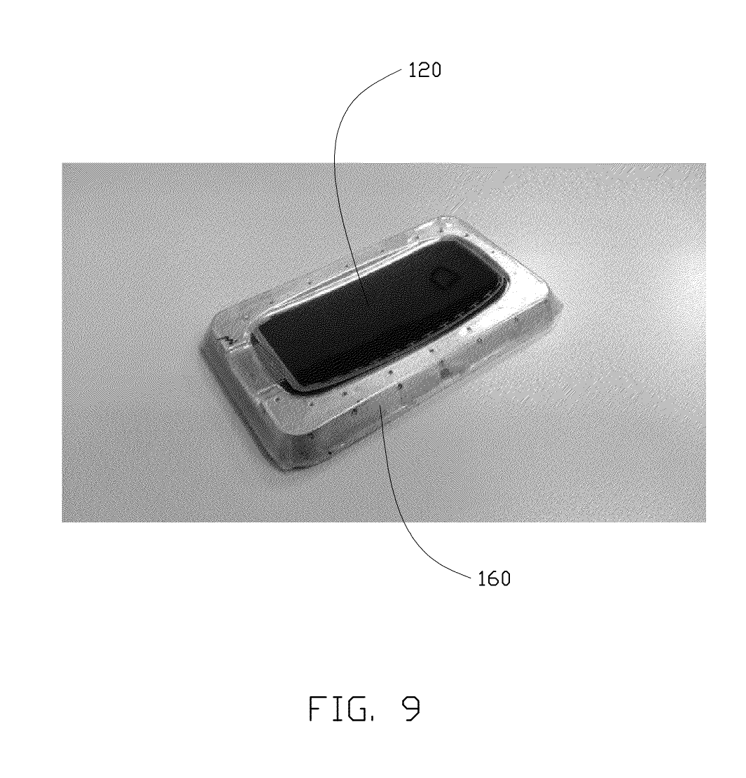

In step (S22), referring to FIGS. 8-9, the material of the mold 160 can be Bakelite (phenolic), or metal such as copper, iron, or other heat-resistant material. The curved surface 161 is a smooth curved surface. The radian θ of the curved surface 161 can be greater than 90 degrees and smaller than 180 degrees. In one embodiment, the radian θ is greater than 90 degrees and smaller than 115 degrees. In another embodiment, the radian θ is greater than 100 degrees and smaller than or equal to 115 degrees. Furthermore, a radius of the curved surface 161 can be less than 5 millimeters. The curved surface 161 can also be a quadric surface or free-form surface.

The curved surface 161 can be a convex surface protruding out of the inside of the mold 160. The curved surface 161 can also be a concave surface sinking into the inside of the mold 160.

In step (S23), the mold 160 can be heated by a furnace 150. The furnace 150 can be a vacuum heating furnace. The furnace 150 comprises a first carrier plate 154 and a second carrier plate 156 spaced from and parallel with each other. The mold 160 can be fixed on the second carrier plate 156, and the curved surface 161 faces the first carrier plate 154. The mold 160 can be heated to the first predetermined temperature by heating the second carrier plate 156 with the furnace 150. Furthermore, the first carrier plate 154 defines a first through hole 1541, and the second carrier plate 156 defines a second through hole 1561. The pressure can be applied on the two opposite surfaces of the carbon nanotube composite structure 120 through the first through hole 1541 and the second through hole 1561.

The first predetermined temperature can be selected according to the material of the carbon nanotube composite structure 120, which ensure that the carbon nanotube composite structure 120 has great flexibility and scalability. In one embodiment, the first predetermined temperature ranges from about 100° C. to about 150° C. A difference between the temperature of the carbon nanotube composite structure 120 and the temperature of the environment in the furnace 150 is smaller than 30° C. Thus the carbon nanotube conductive layer 110 in the carbon nanotube composite structure 120 has great flexibility and scalability.

In step (S24), the carbon nanotube composite structure 120 can face and be spaced from the curved surface 161. In one embodiment, the carbon nanotube composite structure 120 is suspended above the curved surface 161. In another embodiment, because the carbon nanotube composite structure 120 is a planar structure, thus edges of the carbon nanotube composite structure 120 may be in contact with edges of the curved surface 161. But the central portion of the carbon nanotube composite structure 120 can be still suspended and spaced from the curved surface 161.

Furthermore, while the curved surface 161 is the concave surface, the carbon nanotube conductive layer 110 in the carbon nanotube composite structure 120 can face the curved surface 161. While the curved surface 161 is the convex surface, the first substrate 100 in the carbon nanotube composite structure 120 can face the curved surface 161.

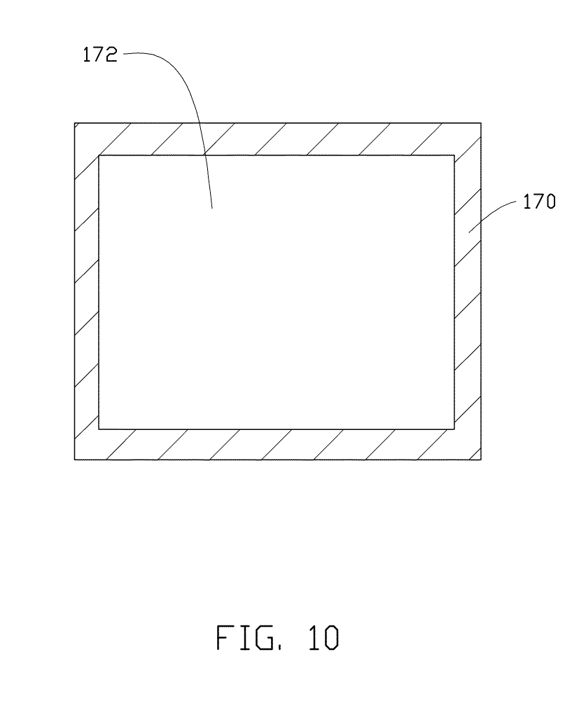

The carbon nanotube composite structure 120 can be fixed in the furnace 150 via a clamp 170 fixed on the inside wall of the furnace 150. The clamp 170 is spaced from the curved surface 161 of the mold 160. Furthermore, the clamp 170 is located among and spaced from the first carrier plate 154 and the second carrier plate 156. Referring to FIG. 10, the clamp 170 is a hollow structure with an opening 172. The carbon nanotube composite structure 120 defines a first portion and a second portion. The first portion of the carbon nanotube composite structure 120 can be fixed on the clamp 170. The second portion is suspended through the opening 172. The carbon nanotube composite structure 120 can be firmly fixed in the furnace 150 through the clamp 170, and the second portion of the carbon nanotube composite structure 120 can be planar or remains natural state. In one embodiment, the clamp 170 is in a shape of fringe frame.

In step (S25), the heating device 180 can be a metallic heating tube. The heating device 180 can generate infrared rays to heat the carbon nanotube composite structure 120. Furthermore, the heating device 180 can be located adjacent to the two opposite surfaces of the carbon nanotube composite structure 120. Thus the carbon nanotube composite structure 120 can be uniformly heated. The temperature of the heating device 180 can range from about 120° C. to about 220° C.

Furthermore, the carbon nanotube composite structure 120 can also be heated via applying a current through the carbon nanotube conductive layer 110. Thus the carbon nanotube conductive layer 110 will generate heat to heat the carbon nanotube composite structure 120. Thus other heating device can be omitted, and the carbon nanotube composite structure 120 can be effectively and uniformly heated.

The second predetermined temperature can be determined according to the material of the carbon nanotube composite structure 120, especially according to the material of the first substrate 100. The carbon nanotube composite structure 120 has great flexibility and plasticity heated under the second predetermined temperature. Furthermore, the second predetermined temperature cannot damage the entire structure of the carbon nanotube composite structure 120. The first substrate 100 cannot be melt under the second predetermined temperature. The temperature of the mold 160 and in the surface 150 ranges from about 100° C. to about 190° C. A difference between the first predetermined temperature and the second predetermined temperature is smaller than 30° C. In one embodiment, the second predetermined temperature is about 120° C.

The first determined time can ensure that the carbon nanotube composite structure 120 can be uniformly heated to the second predetermined temperature. Thus the carbon nanotube composite structure 120 is uniformly flexible. The first predetermined time can range from about 5 seconds to about 30 seconds. In one embodiment, the first predetermined time is about 15 seconds.

In step (S26), the carbon nanotube composite structure 120 can be bent by following substeps:

first substep, fixing the clamp 170 by pushing the first carrier plate 154 and the second carrier plate 156 toward each other;

second substep, applying a positive pressure on the carbon nanotube composite structure 120 through the first carrier plate 154 and applying a negative pressure on the carbon nanotube composite structure 120 through the second carrier plate 156 for a second predetermined time; and

third substep, stopping applying the positive pressure and the negative pressure and separating the first carrier plate 154 and the second carrier plate 156.

In the first substep, the first carrier plate 154 and the second carrier plate 156 can be closed by pushing them toward each other via a hydraulic device or pneumatic device. The clamp 170 can be fixed between the first carrier plate 154 and the second carrier plate 156. The second portion of the carbon nanotube composite structure 120 can also be proximate to the curved surface 161.

In the second substep, the positive pressure can be applied on the carbon nanotube composite structure 120 via an air cylinder through the first carrier plate 154. The positive pressure can push the carbon nanotube composite structure 120 toward the curved surface 161. Since the first portion of the carbon nanotube composite structure has firmly fixed by the clamp 170, the second portion of the carbon nanotube composite structure 120 can be deformed toward the curved surface 161 under the positive pressure. The positive pressure can range from about 2 MPa to about 9 MPa. The carbon nanotube composite structure 120 cannot be damaged under the positive pressure.

At the same time, the negative pressure can be applied on the carbon nanotube composite structure 120 via another air cylinder through the second carrier plate 156. The negative pressure can attract the carbon nanotube composite structure 120 toward the curved surface 161. The second portion of the carbon nanotube composite structure 120 can be deformed toward the curved surface 161 under the negative pressure. The negative pressure can range from about 2 MPa to about 9 MPa. The carbon nanotube composite structure 120 cannot be damaged under the positive pressure and the negative pressure.

Under the positive pressure and the negative pressure, a pressure difference can be formed between the two opposite surfaces of the carbon nanotube composite structure 120. The carbon nanotube composite structure 120 will be gradually attached on the curved surface 161 from the central portion of the carbon nanotube composite structure 120. After all, the entire second portion of the carbon nanotube composite structure 120 will be attached on the curved surface. The shape of the carbon nanotube composite structure 120 will be bent along the curved surface 161. Furthermore, the conductivity of the carbon nanotube composite structure 120 is not affected by the deformation. It can be understood that, in this step, a few of carbon nanotubes may be broken. However, the broken carbon nanotubes do not affect the conductivity and transparence of the carbon nanotube composite structure 120, and the carbon nanotube conductive structure 110 is still a free-standing structure.

It can be understood that the carbon nanotube composite structure 120 can also be bent by merely applying the positive pressure or the negative pressure.

In the third substep, the curved touch module 10 can be obtained by opening the first carrier plate 154 and the second carrier plate 156, and detaching the curved carbon nanotube composite structure 120 from the clamp 170.

Furthermore, the furnace 150 can be divided into a first space and a second space by the carbon nanotube composite structure 120. The mold 160 can be located into the second space. The carbon nanotube conductive layer 110 in the carbon nanotube composite structure 120 can face the curved surface 161 of the mold 160. Thus the carbon nanotube composite structure 120 can be bent toward the mold 160 by forming a pressure difference between the first space and the second space. Then the carbon nanotube composite structure 120 will be eventually attached on the curved surface 161.

The method of making curved touch module 10 has following advantages. The carbon nanotube conductive layer has great flexibility, thus it can be easily bent. The carbon nanotube conductive layer is firstly attached on the first substrate to form the carbon nanotube composite structure before being bent, thus the carbon nanotube conductive layer can be easily and tightly attached on the first substrate. Furthermore, the carbon nanotube conductive layer can be protected from being broken due to the first substrate. Thus the life span of the curved touch module can be improved. The method of making curved touch module is convenient for mass production.

It is to be understood that the described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The disclosure illustrates but does not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method of making curved touch module, the method comprising:
providing a first substrate having a first surface;
forming a carbon nanotube composite structure by attaching a carbon nanotube conductive layer on the first surface;
providing a die having a male die and a female die coupled with each other, wherein the male die comprises a male die surface, and the female die comprises a female die surface coupled with the male die surface;
heating the die to a first predetermined temperature;
placing the carbon nanotube composite structure into the die, wherein the carbon nanotube composite structure is located between the male die and the female die; and
curving the carbon nanotube composite structure by closing the male die and the female die of the die for a first predetermined time.

2. The method of claim 1, wherein a material of the first substrate is a flexible material selected from the group consisting of polycarbonate, polymethyl methacrylate, polyethylene terephthalate and other polyester materials, and polyether sulfone, cellulose esters, polyvinyl chloride, benzocyclobutene, and acrylic resin.

3. The method of claim 1, wherein the first predetermined temperature ranges from about 80° C. to about 120° C.

4. The method of claim 1, wherein the first predetermined time ranges from about 20 seconds to about 180 seconds.

5. The method of claim 1, wherein the carbon nanotube conductive layer is transparent and comprises a plurality of carbon nanotubes substantially aligned along the same direction.

6. The method of claim 5, wherein the plurality of carbon nanotubes are joined end to end by van der Waals force along the same direction.

7. The method of claim 5, wherein and the plurality of carbon nanotubes are parallel with the first surface of the first substrate.

8. The method of claim 1, wherein each of the male die surface and the female die surface is a curved surface, and the curved surface bends along single dimension, two dimensions, or three dimensions.

9. The method of claim 8, wherein the curved surface is a free-form surface.

10. The method of claim 8, wherein a radian θ of the curved surface ranges from about 90 degrees to about 115 degrees, and a radius of the curved surface is smaller than 5 millimeters.

11. The method of claim 1, further comprising a step of applying a second substrate onto the carbon nanotube composite structure.

12. The method of claim 11, wherein the second substrate comprises a second surface capable of being coupled with the male die surface and the female die surface.

13. The method of claim 12, wherein the carbon nanotube conductive layer is sandwiched between the first surface and the second surface.

14. A method of making curved touch module, the method comprising:
proving a first substrate with a first surface;
forming a carbon nanotube composite structure by forming a carbon nanotube conductive layer on the first surface;
providing a mold having a curved surface;
heating the mold to a first predetermined temperature;
suspending the carbon nanotube composite structure above the curved surface;
heating the carbon nanotube composite structure to a second predetermined temperature for a first predetermined time;
attaching the carbon nanotube composite structure on the curved surface by bending the carbon nanotube composite structure towards the curved surface.

15. The method of claim 14, wherein the curved surface is a convex surface or a concave surface.

16. The method of claim 14, wherein the carbon nanotube composite structure is heated to the first predetermined temperature in a furnace, and the carbon nanotube composite structure is suspended above the mold via a clamp fixed on the furnace.

17. The method of claim 16, wherein the furnace comprises a first carrier plate and a second carrier plate spaced from each other, the mold is located on the second carrier plate, and the clamp is located between the first carrier plate and the second carrier.

18. The method of claim 16, wherein a pressure difference is applied on the carbon nanotube composite structure, and the carbon nanotube composite structure is gradually attached on the curve surface with the pressure difference.

19. The method of claim 14, wherein a difference between the first predetermined temperature and the second predetermined temperature is smaller than 30° C.

20. A method of making curved touch module, the method comprising:
proving a carbon nanotube composite structure comprising a first substrate and a carbon nanotube conductive layer located on a first surface of the first substrate;
suspending the carbon nanotube composite structure into a room of a furnace, wherein the room is divided into a first space and a second space by the carbon nanotube composite structure;
placing a mold with a curved surface facing the carbon nanotube composite structure in the room;
heating the carbon nanotube composite structure into a first predetermined temperature by radiation so that the carbon nanotube composite structure is flexible;
bending the carbon nanotube composite structure toward the curved surface until the carbon nanotube composite structure is attached onto the curved surface by applying a pressure difference between the first space and the second space.
